(19) United States
(12) Patent Application Publication
(10) Pub. No.: US 2023/0288745 A1
(43) Pub. Date: Sep. 14, 2023

(54) ARTICLE FOR DISPLAY DEVICE, DISPLAY SYSTEM AND METHOD OF MANUFACTURE

(71) Applicant: 3M INNOVATIVE PROPERTIES COMPANY, St. Paul, MN (US)

(72) Inventors: Chun-Yi Ting, Zhongli District (TW); Chiu-Hsing Lin, Pingzhen District (TW); Juo-Han Chou, Yangmei District (TW); Chun-Lung Chen, Yangmei District (TW); Kazuhiko Toyooka, Yamagata-shi (JP); Yu Hsin Lu, Changhua County (TW)

(21) Appl. No.: 18/007,071

(22) PCT Filed: Aug. 11, 2021
(86) PCT No.: PCT/IB2021/057419

§ 371 Date: Jan. 27, 2023

Related U.S. Application Data
(60) Provisional application No. 63/064,545, filed on Aug. 12, 2020.

(51) Int. Cl. G02F 1/1335; G02F 1/13357

(52) U.S. Cl. CPC G02F 1/133504; G02F 1/1336; G02F 2202/28; G02F 2201/305; G02F 2202/36

(57) ABSTRACT

An article (100) for a display device includes a diffraction grating film (102), a first optically clear adhesive layer (120), and a second optically clear adhesive layer (130). The diffraction grating film includes a base layer (104) and a plurality of microstructures (106) projecting from the base layer. The base layer defines a non-structured surface of the diffraction grating film and the plurality of microstructures define a structured surface of the diffraction grating film opposite to the non-structured surface. The first optically clear adhesive layer is disposed on the structured surface of the diffraction grating film. The second optically clear adhesive layer is disposed on the non-structured surface of the diffraction grating film.

### TECHNICAL FIELD

The present disclosure relates to articles for display devices, display systems including such articles, and methods of manufacturing such articles.

### BACKGROUND

A liquid crystal display (LCD) uses light-modulating properties of liquid crystals. A conventional LCD panel display may have a low on-axis contrast. A dual LCD system may provide a higher contrast and an improved black state than the conventional LCD panel display to compete with a typical organic light-emitting diode (OLED) display in terms of contrast ratio and efficiency. However, laminating a top LCD and a bottom LCD in a dual LCD system may cause optical interference and further cause moiré effect. The moiré effect may be observed as an interference phenomenon when two similar lattices are overlapped. The moiré effect may result from the optical interference between two or more regular structures having different intrinsic frequencies. Since the top LCD and the bottom LCD include a plurality of individually addressable pixels, there can be a possibility of moiré effect between an image formed by the top LCD and an image formed by the bottom LCD. One solution to reduce the optical interference and the moiré effect includes applying a matte coating on a polarizer, however, the matte coating may reduce brightness of the dual LCD system.

A standard optically clear adhesive (OCA) may not reduce the optical interference and the moiré effect. It may therefore be desirable to have an optically clear adhesive that helps in reducing the optical interference and the moiré effect without affecting the brightness and the clarity of the dual LCD system.

### SUMMARY

Generally, the present disclosure relates to articles for display devices. The present disclosure also relates to display systems including such articles, and methods of manufacturing such articles.

Some embodiments of the present disclosure relate to an article for a display device including a diffraction grating film, a first optically clear adhesive layer, and a second optically clear adhesive layer. The diffraction grating film includes a base layer and a plurality of microstructures projecting from the base layer. The base layer defines a non-structured surface of the diffraction grating film and the plurality of microstructures define a structured surface of the diffraction grating film opposite to the non-structured surface. The first optically clear adhesive layer is disposed on the structured surface of the diffraction grating film. The second optically clear adhesive layer is disposed on the non-structured surface of the diffraction grating film.

In some embodiments, the base layer defines a longitudinal axis along its length and the plurality of microstructures extends along the base layer to define a primary axis.

The primary axis and the longitudinal axis define a bias angle therebetween. The bias angle is in a range of between about 0 degree and about 90 degrees.

In some embodiments, the bias angle is in a range of between about 20 degrees and about 70 degrees.

In some embodiments, the plurality of microstructures has a peak to valley height in a range of between about 2.4 microns and about 10 microns.

In some embodiments, the plurality of microstructures has a pitch in a range of between about 2 microns and about 50 microns.

In some embodiments, each microstructure is substantially prismatic.

In some embodiments, the first optically clear adhesive layer has a refractive index of between about 1.47 and about 1.49.

In some embodiments, the second optically clear adhesive layer has a refractive index of between about 1.47 and about 1.49.

In some embodiments, a thickness of the first optically clear adhesive layer is greater than the peak to valley height of the plurality of microstructures.

In some embodiments, the article further includes a first release liner immediately adjacent to the first optically clear adhesive layer and a second release liner immediately adjacent to the second optically clear adhesive layer.

Some embodiments of the present disclosure relate to a display system including an illumination source, a first liquid crystal assembly, a second liquid crystal assembly, and an article. The illumination source is configured to emit light over an emission surface of the illumination source and includes at least one light source. The first liquid crystal assembly is configured to selectively transmit and reflect light received from the emission surface of the illumination source. The second liquid crystal assembly is configured to receive light from the first liquid crystal assembly and emit an image for viewing by a viewer. The second liquid crystal assembly is disposed on the first liquid crystal assembly. The article is disposed between the first liquid crystal assembly and the second liquid crystal assembly. The article includes a diffraction grating film, a first optically clear adhesive layer, and a second optically clear adhesive layer. The diffraction grating film includes a base layer and a plurality of microstructures projecting from the base layer. The base layer defines a non-structured surface of the diffraction grating film and the plurality of microstructures define a structured surface of the diffraction grating film opposite to the non-structured surface. The first optically clear adhesive layer is disposed on the structured surface of the diffraction grating film. The second optically clear adhesive layer is disposed on the non-structured surface of the diffraction grating film.

Some embodiments of the present disclosure relate to a method of manufacturing an article for use with a display device. The method includes providing a diffraction grating film including a base layer and a plurality of microstructures projecting from the base layer. The base layer defines a non-structured surface of the diffraction grating film and the plurality of microstructures define a structured surface of the diffraction grating film opposite to the non-structured surface. The method further includes providing a first optically clear adhesive layer on the structured surface of the diffraction grating film. The method further includes providing a second optically clear adhesive layer on the non-structured surface of the diffraction grating film.

In some embodiments, the method further includes rotating the diffraction grating film to a bias angle after providing the first optically clear adhesive layer and the second optically clear adhesive layer on the diffraction grating film.

In some embodiments, the method further includes rotating the diffraction grating film to a bias angle prior to providing the first optically clear adhesive layer and the second optically clear adhesive layer on the diffraction grating film.

In some embodiments, the method further includes die cutting the diffraction grating film to a bias angle after providing the first optically clear adhesive layer and the second optically clear adhesive layer on the diffraction grating film.

In some embodiments, the method further includes die cutting the diffraction grating film to a bias angle prior to providing the first optically clear adhesive layer and the second optically clear adhesive layer on the diffraction grating film.

In some embodiments, the bias angle is in a range of between about 20 degrees and about 70 degrees.

### BRIEF DESCRIPTION OF THE DRAWINGS

Exemplary embodiments disclosed herein may be more completely understood in consideration of the following detailed description in connection with the following figures. The figures are not necessarily drawn to scale. Like numerals used in the FIGS. refer to like components. When pluralities of similar elements are present, a single reference numeral may be assigned to each plurality of similar elements with a small letter designation referring to specific elements. When referring to the elements collectively or to a non-specific one or more of the elements, the small letter designation may be eliminated. However, it will be understood that the use of a numeral to refer to a component in a given figure is not intended to limit the component in another figure labeled with the same number.

FIG. 1 illustrates a cross-sectional view of an article according to an embodiment of the present disclosure;

FIG. 2 illustrates a partial schematic view of a plurality of microstructures having an exemplary bias angle according to another embodiment of the present disclosure;

FIG. 3 is a cross-sectional view of a display system according to an embodiment of the present disclosure;

FIG. 4 is a flowchart for a method of manufacturing an article for use with a display device according to an embodiment of the present disclosure;

FIGS. 5A-5C illustrate preparation of an article according to an embodiment of the present disclosure; and

FIGS. 6A-6C illustrate preparation of an article according to another embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

As recited herein, all numbers should be considered modified by the term “about”.

As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

As used herein, layers, components, or elements may be described as being adjacent one another. Layers, components, or elements can be adjacent one another by being in direct contact, by being connected through one or more other components, or by being held next to one another or attached to one another. Layers, components, or elements that are in direct contact may be described as being immediately adjacent.

The present disclosure relates to an article. The article may be used in a display system. In some embodiments, the article may be used in a dual Liquid Crystal Display (LCD) system. The present disclosure also relates to a method of manufacturing the article for use with the display device. The article includes a diffraction grating film, a first optically clear adhesive, and a second optically clear adhesive.

A moiré effect and an optical interference may be observed when two similar lattices are overlapped. The moiré effect may result from the optical interference among two or more regular structures having different intrinsic frequencies. The display system of the present disclosure includes an illumination source, a first liquid crystal assembly and a second liquid crystal assembly. Since each of the first liquid crystal assembly and the second liquid crystal assembly includes a plurality of individually addressable pixels, there can be a possibility of the moiré effect between an image formed by the first liquid crystal assembly and an image formed by the second liquid crystal assembly.

By including the article in the display system, the optical interference and the moiré effect may be substantially reduced without affecting a brightness and a clarity of the display system.

The term “optically clear adhesive”, as used herein, refers to an adhesive that exhibits an optical transmission of at least about 80%, as measured on a sample having a thickness from about 25 microns (μm) to about 250 μm. In some embodiments, the optical transmission may be at least about 85%, 90%, 95% or even higher.

The term “microstructures”, as used herein, are generally projections, protrusions and/or indentations in the surface of an article that deviate in profile from an average center line drawn through the microstructure.

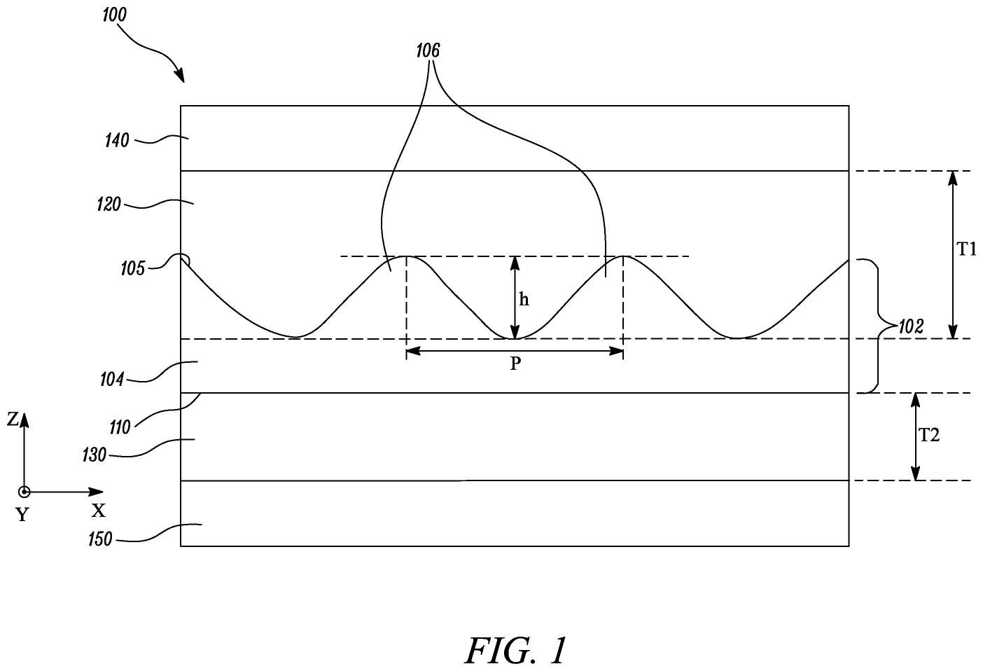

FIG. 1 illustrates a cross-sectional view of an article 100 for a display device according to the present disclosure. The article 100 includes a diffraction grating film 102, a first optically clear adhesive layer 120, and a second optically clear adhesive layer 130. The article 100 defines mutually orthogonal X, Y and Z-axes. The X and Y-axes are in-plane axes of the article 100, while the Z-axis is a transverse axis disposed along a thickness of the article 100. In other words, the X and Y-axes are disposed along a plane of the article 100, while the Z-axis is perpendicular to the plane of the article 100. The diffraction grating film 102, the first optically clear adhesive layer 120, and the second optically clear adhesive layer 130 of the article 100 are disposed adjacent to each other along the Z-axis.

The diffraction grating film 102 includes a base layer 104 and a plurality of microstructures 106 projecting from the base layer 104.

The base layer 104 further defines a non-structured surface 110 of the diffraction grating film 102. The non-structured surface 110 is a substantially planar surface. The plurality of microstructures 106 further define a structured surface 105 of the diffraction grating film 102 opposite to the non-structured surface 110.

In some embodiments, the structured surface 105 may have any periodically repeating shape, for example, a sinusoidal shape, a square wave shape, a cube-corner shape, a triangular shape, and so forth. In some other embodiments, the structured surface 105 may have any other periodically repeating regular or irregular shapes.

In some embodiments, the base layer 104 includes a polymerizable resin or any other suitable material. In some embodiments, the polymerizable resin may include a combination of a first polymerizable component and a second polymerizable component selected from (meth)acrylate monomers, (meth)acrylate oligomers, and mixtures thereof. As used herein, “monomer” or “oligomer” is any substance that can be converted into a polymer. The term “(meth)acrylate” refers to both acrylate and methacrylate compounds. In some cases, the polymerizable composition may include a (meth)acrylated urethane oligomer, (meth)acrylated epoxy oligomer, (meth)acrylated polyester oligomer, a (meth)acrylated phenolic oligomer, a (meth)acrylated acrylic oligomer, and mixtures thereof.

In some embodiments, each of the plurality of microstructures 106 has a peak to valley height h in a range of between about 2.4 microns and about 10 microns. In some other embodiments, the peak to valley height h of each microstructure 106 is in a range of between about 5 microns and about 20 microns. The peak to valley height h of each microstructure 106 may vary based on application requirements.

In some embodiments, the plurality of microstructures 106 has a pitch P in a range of between about 2 microns and about 50 microns. In some other embodiments, the pitch P of the plurality of microstructures 106 is in a range of between about 10 microns and about 80 microns. The pitch P of the plurality of microstructures 106 may vary based on application requirements.

In the illustrated embodiment of FIG. 1, each microstructure 106 is substantially prismatic. In some other embodiments, each microstructure 106 may have a substantial hemispherical shape, a substantial conical shape, a substantial cuboidal shape, and so forth. The plurality of microstructures 106 may have any suitable shape as per application requirements.

In some embodiments, the microstructures 106 are arranged in multiple rows. The rows of the microstructures 106 may be uniformly or non-uniformly spaced apart from each other. A distance between adjacent rows may be selected as per application requirements. In some embodiments, the pitch P of the microstructures 106 may vary periodically or nonperiodically in one or more rows. In some embodiments, the peak to valley height h of the microstructures 106 may vary periodically or nonperiodically in one or more rows.

The first optically clear adhesive layer 120 is disposed on the structured surface 105 of the diffraction grating film 102. In some embodiments, the first optically clear adhesive layer 120 has a refractive index of between about 1.47 and about 1.49. In some other embodiments, the refractive index of the first optically clear adhesive layer 120 is of between about 1.49 and about 1.51. The first optically clear adhesive layer 120 may include any type of adhesive material, such as a liquid adhesive, an acrylate, a pressure sensitive adhesive, a stretch release adhesive, an adhesive foam, etc. The present disclosure is not limited by type of adhesive in any manner. A thickness T1 of the first optically clear adhesive layer 120 may vary as per application requirements. The thickness T1 of the first optically clear adhesive layer 120 is greater than the peak to valley height h of the plurality of microstructures 106 (i.e., T1>h).

The second optically clear adhesive layer 130 is disposed on the non-structured surface 110 of the diffraction grating film 102. In some embodiments, the second optically clear adhesive layer 130 has a refractive index of between about 1.47 and about 1.49. In some other embodiments, the refractive index of the second optically clear adhesive layer 130 is of between about 1.49 and about 1.51. The second optically clear adhesive layer 130 may include any type of adhesive material, such as a liquid adhesive, an acrylate, a pressure sensitive adhesive, a stretch release adhesive, an adhesive foam, etc. The present disclosure is not limited by type of adhesive in any manner. A thickness T2 of the second optically clear adhesive layer 130 may vary as per application requirements.

The article 100 includes the first optically clear adhesive layer 120 and second optically clear adhesive layer 130 so that the diffraction grating film 102 may be used to laminate the article 100 to another layer or to a surface, for example, of a display device.

In the illustrated embodiment of FIG. 1, the article 100 further includes a first release liner 140 and a second release liner 150. The first release liner 140 is immediately adjacent to the first optically clear adhesive layer 120. In some embodiments, the first release liner 140 may include an anti-static tight liner, an easy liner, and so forth. The present disclosure is not limited by type of release liner in any manner.

The second release liner 150 is immediately adjacent to the second optically clear adhesive layer 130. In some embodiments, the second release liner 150 may include an anti-static tight liner, an easy liner, and so forth. The present disclosure is not limited by type of release liner in any manner.

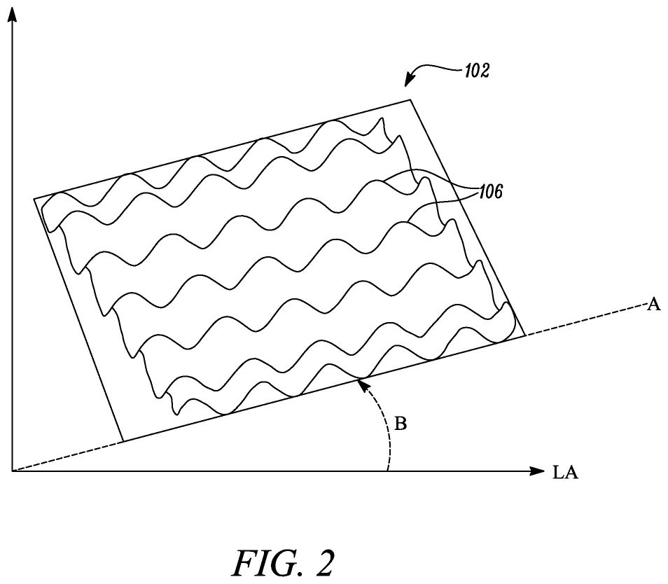

FIG. 2 illustrates a partial schematic view of the diffraction grating film 102 including the plurality of microstructures 106. In the illustrated embodiment, each of the plurality of microstructures 106 is substantially prismatic. FIG. 2 further illustrates the plurality of microstructures 106 having an exemplary bias angle.

Referring now to FIGS. 1 and 2, the base layer 104 defines a longitudinal axis LA along its length and the plurality of microstructures 106 extends along the base layer 104 to define a primary axis A. In some embodiments, the longitudinal axis LA of the base layer 104 may be parallel to the X-axis of the article 100. The primary axis A and the longitudinal axis LA define a bias angle B therebetween. In some embodiments, the bias angle B is in a range of between about 0 degrees and about 90 degrees. In some embodiments, the bias angle B is in a range of between about 20 degrees and about 70 degrees.

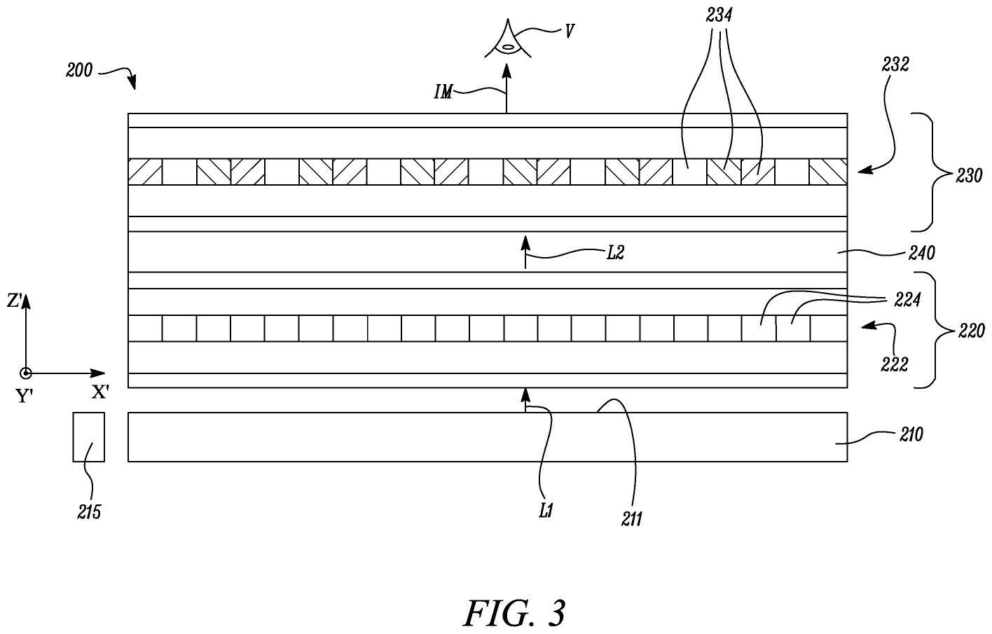

FIG. 3 is a cross-sectional view of a display system 200 according to an embodiment of the present disclosure. The display system 200 includes an illumination source 210, a first liquid crystal assembly 220, a second liquid crystal assembly 230, and an article 240.

The display system 200 defines mutually orthogonal X′, Y′ and Z′-axes. The X′ and Y′-axes are in-plane axes of the display system 200, while the Z′-axis is a transverse axis disposed along a thickness of the display system 200. In other words, the X′ and Y′-axes are disposed along a plane of the display system 200, while the Z′-axis is perpendicular to the plane of the display system 200. The illumination source 210, the first liquid crystal assembly 220, the second liquid crystal assembly 230, and the article 240 of the display system 200 are disposed adjacent to each other along the Z′-axis.

The illumination source 210 is configured to emit light L1 over an emission surface 211 of the illumination source 210. The illumination source 210 includes at least one light source 215. The at least one light source 215 generates light that illuminates the display system 200. In some embodiments, the at least one light source 215 includes one or more light emitters which emit light. The light emitters may be, for example, light emitting diodes (LEDs), fluorescent lights, or any other suitable light emitting device. The LEDs may be monochromatic, or may include a number of emitters operating at different wavelengths in order to produce a white light output. In the illustrated embodiment of FIG. 3, the at least one light source 215 is disposed at an edge surface of the illumination source 210. In some other embodiments, the at least one light source 215 may be located proximate a longitudinal surface of the illumination source 210.

The first liquid crystal assembly 220 is configured to selectively transmit and reflect light L1 received from the emission surface 211 of the illumination source 210. In some embodiments, the first liquid crystal assembly 220 and the illumination source 210 are bonded together, for example, by means of an optically clear adhesive, epoxy, lamination, or any other suitable method of attachment. In some embodiments, the first liquid crystal assembly 220 includes a first liquid crystal panel 222. In some embodiments, the first liquid crystal panel 222 includes a plurality of individually addressable pixels 224. In some embodiments, the first liquid crystal assembly 220 is a monochrome display. In other words, the first liquid crystal assembly 220 does not include a color filter.

The second liquid crystal assembly 230 is configured to receive light L2 from the first liquid crystal assembly 220 and emit an image IM for viewing by a viewer V. The second liquid crystal assembly 230 includes a second liquid crystal panel 232. In some embodiments, the second liquid crystal panel 232 includes a plurality of individually addressable pixels 234. In some embodiments, the second liquid crystal assembly 230 is a color display. In other words, the second liquid crystal assembly 230 includes a color filter.

The second liquid crystal assembly 230 is disposed on the first liquid crystal assembly 220. The second liquid crystal assembly 230 and the first liquid crystal assembly 220 are bonded to each other by means of the article 240.

The article 240 is substantially similar to the article 100 of FIG. 1. However, the article 240 does not include the first release liner 140 and the second release liner 150 of the article 100 as shown in FIG. 1.

A moiré effect and an optical interference may be observed when two similar lattices are overlapped. The moiré effect may result from the optical interference among two or more regular structures having different intrinsic frequencies. Since the plurality of individually addressable pixels 224, 234 of the first liquid crystal panel 222 and the second liquid crystal panel 232 have regular pitch structures, there can be a possibility of a moiré effect between an image formed by the first liquid crystal assembly 220 and an image formed by the second liquid crystal assembly 230.

By including the article 240 in the display system 200, the optical interference and the moiré effect may be substantially reduced without affecting a brightness and a clarity of the display system 200.

Referring to FIGS. 1-3, the diffraction grating film 102 including the structured surface 105 or structured interface may provide useful optical effects. For example, the structured surface 105 may provide diffraction of a light that is transmitted through the article 240. According to the present disclosure, a diffraction grating film (for example, the diffraction grating film 102 shown in FIG. 1) may be selected to reduce moiré when included between two optically clear adhesive layers (for example, the first and second optically clear adhesive layers 120, 130 shown in FIG. 1). An article including the diffraction grating film and the two optically clear adhesive layers is placed over a display panel, or placed between a backlight and a display panel.

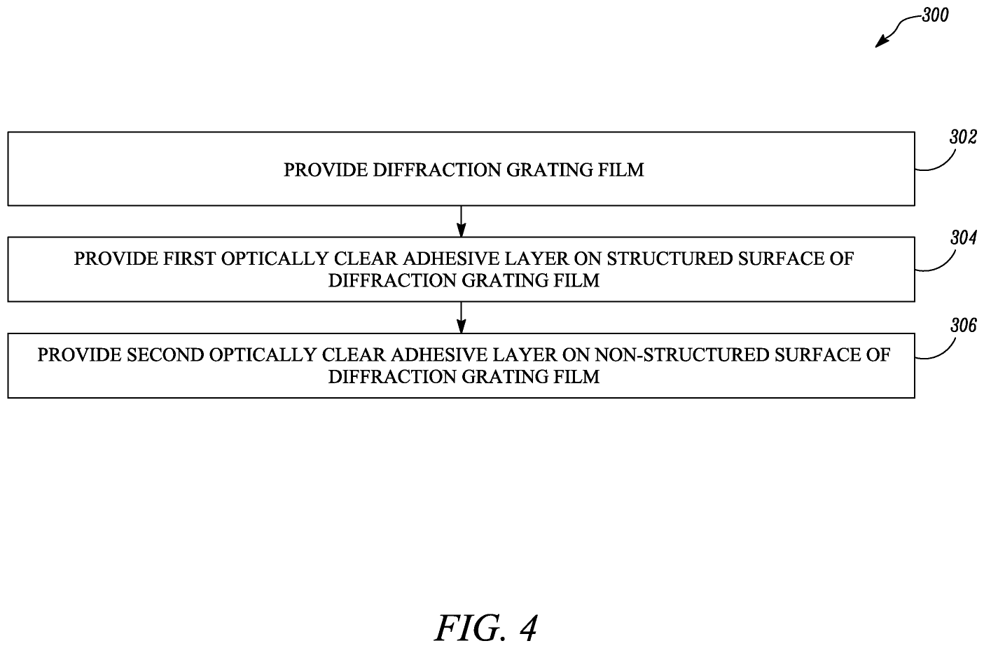

Referring to FIG. 4, the present disclosure further provides a method 300 of manufacturing the article 100 shown in FIG. 1 for use with a display device. The method 300 may also be used to manufacture the article 240 for use with the display system 200 shown in FIG. 3.

Referring to FIGS. 1-4, at step 302, the method 300 includes providing the diffraction grating film 102 including the base layer 104 and the plurality of microstructures 106 projecting from the base layer 104. The base layer 104 defines the non-structured surface 110 of the diffraction grating film 102 and the plurality of microstructures 106 define the structured surface 105 of the diffraction grating film 102 opposite to the non-structured surface 110.

The microstructures 106 may be formed on the base layer 104 by various methods, such as extrusion, cast-and-cure, coating, or some other method. In some cases, the microstructures 106 may be micro-replicated on the base layer 104. A typical micro-replication process includes depositing a polymerizable composition onto a master negative microstructured molding surface in an amount barely sufficient to fill the cavities of the master. The cavities are then filled by moving a bead of the polymerizable composition between a preformed base or substrate layer (for example, the base layer 104) and the master. The composition is then cured.

At step 304, the method 300 includes providing the first optically clear adhesive layer 120 on the structured surface 105 of the diffraction grating film 102.

At step 306, the method 300 includes providing the second optically clear adhesive layer 130 on the non-structured surface 110 of the diffraction grating film 102.

In some embodiments, the method 300 may include rotating the diffraction grating film 102 to the bias angle B after providing the first optically clear adhesive layer 120 and the second optically clear adhesive layer 130 on the diffraction grating film 102. In some other embodiments, the method 300 may include rotating the diffraction grating film 102 to the bias angle B prior to providing the first optically clear adhesive layer 120 and the second optically clear adhesive layer 130 on the diffraction grating film 102.

In some embodiments, the method 300 may include die cutting the diffraction grating film 102 to the bias angle B after providing the first optically clear adhesive layer 120 and the second optically clear adhesive layer 130 on the diffraction grating film 102. In some other embodiments, the method 300 may include die cutting the diffraction grating film 102 to the bias angle B prior to providing the first optically clear adhesive layer 120 and the second optically clear adhesive layer 130 on the diffraction grating film 102. In some embodiments, the bias angle B is in a range from about 20 degrees to about 70 degrees.

### Examples

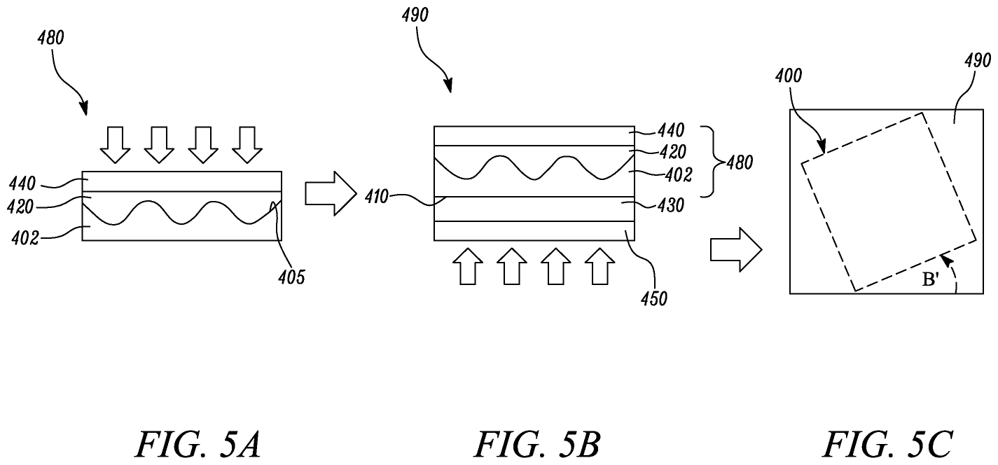

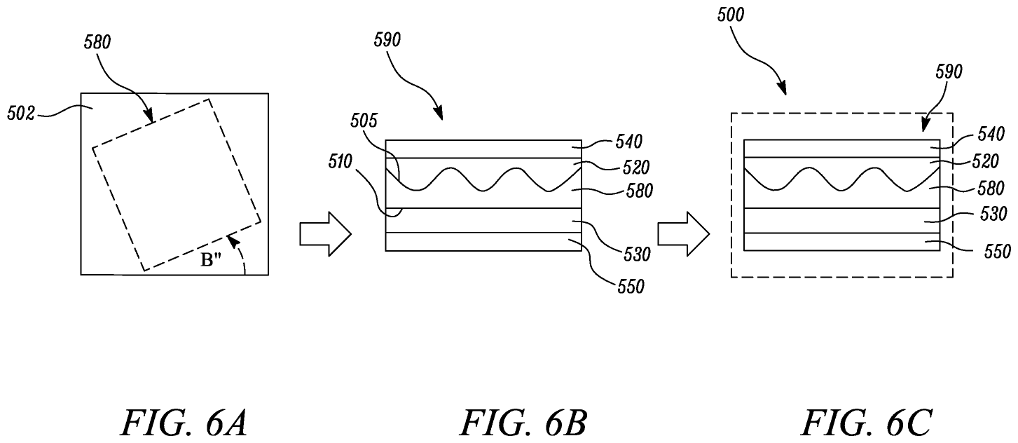

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis. The following examples explain exemplary preparation of an article of the present disclosure. The examples will be explained with reference to FIGS. 5A-5C and 6A-6C.

Table 1 provided below lists some exemplary materials that are used for the preparation of different articles for comparison. G′ in Table 1 refers to the shear storage modulus of a corresponding material. Further, Tg in Table 1 refers to the glass transition temperature of the corresponding material.

TABLE 1
Material List

| | | Refractive | | | |
|---|---|---|---|---|---|
| Category | Description | Index | Thickness | | Details |
| OCA | First Adhesive | 1.47-1.48 | 125 | μm | G′ 6.4 × 10⁴ Pa@25° C., 2.9 × 10⁴ Pa |
| | | | | | @50° C., Tg: −12.9° C. |
| | First Control | 1.47-1.48 | 250 | μm | G′ 6.4 × 10⁴ Pa @25° C., 2.9 × 10⁴ Pa |
| | OCA (First | | | | @50° C., Tg: −12.9° C. |
| | Adhesive) | | | | |
| | Second Control | 1.47-1.48 | 250 | μm | G′ 5.3 × 10⁴ Pa @25° C., 1.4 × 10⁴ Pa |
| | OCA (Second | | | | @50° C., Tg: −17.3° C. |
| | Adhesive) | | | | |
| Liquid OCA | Liquid Adhesive | 1.47-1.48 | 50 μm/100 μm | | After polymerization/G′ 1.25 × 10⁵ Pa |
| | | | | | @25° C., 3.2 × 10⁴ Pa @50° C., |
| | | | | | Tg: −2.98° C. |
| Diffraction | Bias 0 degree | — | 50~60 | μm | Polyethylene terephthalate (PET) substrate |
| Grating Film | Bias 10 degrees | | | | with diffraction grating prism |
| | Bias 20 degrees | | | | microstructure |
| | Bias 30 degrees | | | | |
| | Bias 45 degrees | | | | |
| | Bias 60 degrees | | | | |
| | Bias 70 degrees | | | | |
| | Bias 80 degrees | | | | |
| | Bias 90 degrees | | | | |
| Diffusion | — | — | 50 | μm | High Haze Diffuse Film |
| Film | Tight Liner | 1.6 | | | Anti-static type/Non Anti-static type Tight |
| Liner | | | | | Liner - 75 μm |
| | Easy Liner | 1.6 | | | Anti-static type/Non Anti-static type Easy |
| | | | | | Liner type - 75 μm |

### Sample Preparation

Two sample articles were prepared without a diffraction grating film. Specifically, first and second control OCAs were prepared without a diffraction grating film. The first control OCA was prepared using a first adhesive and the second control OCA was prepared using a second adhesive. The first control OCA and the second control OCA were both 250 microns thick and were prepared by a polymerization process.

Sample articles S1 to S11 were prepared with each including a diffraction grating film. Sample articles S1 to S9 were prepared using a direct coating process. Sample articles S10 and S11 were prepared using a lamination process.

The direct coating process is illustrated in FIGS. 5A-5C. FIGS. 5A-5C illustrate first, second, and third steps, respectively of the direct coating process.

In the first step, a liquid adhesive 420 and an easy liner 440 were coated on a structured surface 405 of a diffraction grating film 402 to obtain a thickness of 100 microns. The diffraction grating film 402, the liquid adhesive 420, and the easy liner 440 went through the polymerization process to obtain a first OCA-Grating Film sample 480.

In the second step, a liquid adhesive 430 and a tight liner 450 were coated on a non-structured surface 410 of the diffraction grating film 402 of the first OCA-Grating Film sample 480 and went through the polymerization process to obtain a second OCA-Grating Film sample 490.

In the third step, the second OCA-Grating Film sample 490 was cut into a bias angle B′ by a plotter to obtain an article 400.

The lamination process is illustrated in FIGS. 6A-6C. FIGS. 6A-6C illustrate first, second, and third steps, respectively of the lamination process.

In the first step, a diffraction grating film 502 was cut into a bias angle B″ by a plotter to obtain to obtain a biased diffraction grating film 580.

In the second step, both sides of the biased diffraction grating film 580 were laminated with the first adhesive to obtain a laminated diffraction grating film 590. Specifically, a structured surface 505 of the biased diffraction grating film 580 was laminated with a first optically clear adhesive layer 520 including the first adhesive and a first liner 540. A non-structured surface 510 of the biased diffraction grating film 580 was laminated with a second optically clear adhesive layer 530 including the first adhesive and a second liner 550.

In the third step, autoclave was applied to the laminated diffraction grating film 590 to obtain an article 500.

Sample article S12 was prepared using a diffusion film, specifically, a high haze diffusion film. The first adhesive was laminated to both sides of the diffusion film.

### Sample Evaluation

Optical performance and moiré were evaluated for the prepared samples.

Total transmittance %, haze % and clarity % were measured for evaluating optical performance of the prepared sample articles. The prepared sample articles were laminated to a glass and sandwiched with an additional glass (80 mm×50 mm×0.7 mm). Autoclave conditions were applied (50 degrees Celsius, 3 kg/cm², 20 min). Further, total transmittance, haze and clarity of the prepared sample articles were measured by a haze meter (BYK haze-gard I).

For evaluating moiré, a light control film was placed on a display module to observe moiré effect. The prepared sample articles were tested.

Tables 2 and 3 below include some exemplary results of optical performance evaluation and moiré evaluation test of the prepared sample articles.

TABLE 2
Optical Performance Evaluation Result

| | | | | Total | | |
|---|---|---|---|---|---|---|
| | | | | Transmittance | Haze | Clarity |
| Sample # | Upper OCA | Middle Film | Lower OCA | (%) | (%) | (%) |
| First Control | First Adhesive | — | — | 91.9% | 0.13% | 100% |
| OCA | (250 μm) | | | | | |
| Second | Second | — | — | 83.8% | 51.4% | 99.5% |
| Control | Adhesive | | | | | |
| OCA | (250 μm) | | | | | |
| S1 | Liquid | Diffraction | Liquid | 89.4% | 72% | 99.7% |
| | Adhesive 1 | Grating Film | Adhesive 2 | | | |
| | | bias 0 degree | | | | |
| S2 | Liquid | Diffraction | Liquid | 89.9% | 73% | 99.7% |
| | Adhesive 1 | Grating Film | Adhesive 2 | | | |
| | | bias 10 degrees | | | | |
| S3 | Liquid | Diffraction | Liquid | 89.8% | 73% | 99.7% |
| | Adhesive 1 | Grating Film | Adhesive 2 | | | |
| | | bias 20 degrees | | | | |
| S4 | Liquid | Diffraction | Liquid | 89.8% | 72.8% | 99.7% |
| | Adhesive 1 | Grating Film | Adhesive 2 | | | |
| | | bias 30 degrees | | | | |
| S5 | Liquid | Diffraction | Liquid | 89.5% | 71.8% | 99.7% |
| | Adhesive 1 | Grating Film | Adhesive 2 | | | |
| | | bias 45 degrees | | | | |
| S6 | Liquid | Diffraction | Liquid | 89.7% | 73% | 99.7% |
| | Adhesive 1 | Grating Film | Adhesive 2 | | | |
| | | bias 60 degrees | | | | |
| S7 | Liquid | Diffraction | Liquid | 89.4% | 73.1% | 99.7% |
| | Adhesive 1 | Grating Film | Adhesive 2 | | | |
| | | bias 70 degrees | | | | |
| S8 | Liquid | Diffraction | Liquid | 89.8% | 73.2% | 99.7% |
| | Adhesive 1 | Grating Film | Adhesive 2 | | | |
| | | bias 80 degree | | | | |
| S9 | Liquid | Diffraction | Liquid | 89.8% | 73.1% | 99.7% |
| | Adhesive 1 | Grating Film | Adhesive 2 | | | |
| | | bias 90 degrees | | | | |
| S10 | First Adhesive | Diffraction | First | 90.0% | 65.6% | 99.8% |
| | (125 μm) | Grating Film | Adhesive | | | |
| | | bias 0 degree | (125 μm) | | | |
| S11 | First Adhesive | Diffraction | First | 90.5% | 65.7% | 99.7% |
| | (125 μm) | Grating Film | Adhesive | | | |
| | | bias 45 degrees | (125 μm) | | | |
| S12 | First Adhesive | Diffusion Film | First | 60.8% | 100% | 59.2% |
| | (125 μm) | | Adhesive | | | |
| | | | (125 μm) | | | |

TABLE 3
Moiré Evaluation Result

| Sample # | Upper OCA | Middle Film | Lower OCA | Moiré |
|---|---|---|---|---|
| First Control | First Adhesive | — | — | Not Good |
| OCA | (250 μm) | | | |
| Second Control | Second Adhesive | — | — | Not Good |
| OCA | (250 μm) | | | |
| S1 | Liquid Adhesive 1 | Diffraction | Liquid Adhesive 2 | Not Good |
| | | Grating Film | | |
| | | bias 0 degree | | |
| S2 | Liquid Adhesive 1 | Diffraction | Liquid Adhesive 2 | Improved but still |
| | | Grating Film | | unsatisfactory |
| | | bias 10 degrees | | |
| S3 | Liquid Adhesive 1 | Diffraction | Liquid Adhesive 2 | PASS/no moiré |
| | | Grating Film | | |
| | | bias 20 degrees | | |
| S4 | Liquid Adhesive 1 | Diffraction | Liquid Adhesive 2 | PASS/no moiré |
| | | Grating Film | | |
| | | bias 30 degrees | | |
| S5 | Liquid Adhesive 1 | Diffraction | Liquid Adhesive 2 | PASS/no moiré |
| | | Grating Film | | |
| | | bias 45 degrees | | |
| S6 | Liquid Adhesive 1 | Diffraction | Liquid Adhesive 2 | PASS/no moiré |
| | | Grating Film | | |
| | | bias 60 degrees | | |
| S7 | Liquid Adhesive 1 | Diffraction | Liquid Adhesive 2 | PASS/no moiré |
| | | Grating Film | | |
| | | bias 70 degrees | | |
| S8 | Liquid Adhesive 1 | Diffraction | Liquid Adhesive 2 | Improved but still |
| | | Grating Film | | unsatisfactory |
| | | bias 80 degrees | | |
| S9 | Liquid Adhesive 1 | Diffraction | Liquid Adhesive 2 | Not Good |
| | | Grating Film | | |
| | | bias 90 degrees | | |
| S10 | First Adhesive | Diffraction | First Adhesive | Not Good |
| | (125 μm) | Grating Film | (125 μm) | |
| | | bias 0 degree | | |
| S11 | First Adhesive | Diffraction | First Adhesive | PASS/no moiré |
| | (125 μm) | Grating Film | (125 μm) | |
| | | bias 45 degrees | | |
| S12 | First Adhesive | Diffusion Film | First Adhesive | PASS/no moiré |
| | (125 μm) | | (125 μm) | |

The sample articles S3-S7 and S11 showed no moiré. The sample articles S2 and S8 showed a reduced but substantial amount of moiré and high total transmittance and clarity. Sample article S12 also showed no moiré, but low total transmittance and clarity. The moiré was observed to be significantly reduced in sample articles including a diffraction grating film having a bias angle in a range from about 20 degrees to about 70 degrees without affecting brightness and clarity.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An article for a display device, the article comprising:
a diffraction grating film comprising a base layer and a plurality of microstructures projecting from the base layer, wherein the base layer defines a non-structured surface of the diffraction grating film and the plurality of microstructures define a structured surface of the diffraction grating film opposite to the non-structured surface;
a first optically clear adhesive layer disposed on the structured surface of the diffraction grating film; and
a second optically clear adhesive layer disposed on the non-structured surface of the diffraction grating film.

2. The article of claim 1, wherein the base layer defines a longitudinal axis along its length and the plurality of microstructures extends along the base layer to define a primary axis, wherein the primary axis and the longitudinal axis define a bias angle therebetween, and wherein the bias angle is in a range of between about 0 degrees and about 90 degrees.

3. The article of claim 2, wherein the bias angle is in a range of between about 20 degrees and about 70 degrees.

4. The article of claim 1, wherein the plurality of microstructures has a peak to valley height in a range of between about 2.4 microns and about 10 microns.

5. The article of claim 1, wherein the plurality of microstructures has a pitch in a range of between about 2 microns and about 50 microns.

6. The article of claim 1, wherein each microstructure is substantially prismatic.

7. The article of claim 1, wherein at least one of the first optically clear adhesive layer and the second optically clear adhesive layer has a refractive index of between about 1.47 and about 1.49.

8. The article of claim 1, wherein a thickness of the first optically clear adhesive layer is greater than a peak to valley height of the plurality of microstructures.

9. The article of claim 1, further comprising:
a first release liner immediately adjacent to the first optically clear adhesive layer; and
a second release liner immediately adjacent to the second optically clear adhesive layer.

10. A display system comprising:
an illumination source configured to emit light over an emission surface of the illumination source and comprising at least one light source;
a first liquid crystal assembly configured to selectively transmit and reflect light received from the emission surface of the illumination source;
a second liquid crystal assembly configured to receive light from the first liquid crystal assembly and emit an image for viewing by a viewer, the second liquid crystal assembly disposed on the first liquid crystal assembly; and
an article disposed between the first liquid crystal assembly and the second liquid crystal assembly, the article comprising:
a diffraction grating film comprising a base layer and a plurality of microstructures projecting from the base layer, wherein the base layer defines a non-structured surface of the diffraction grating film and the plurality of microstructures define a structured surface of the diffraction grating film opposite to the non-structured surface;
a first optically clear adhesive layer disposed on the structured surface of the diffraction grating film; and
a second optically clear adhesive layer disposed on the non-structured surface of the diffraction grating film.

11. The display system of claim 10, wherein the base layer defines a longitudinal axis along its length and the plurality of microstructures extends along the base layer to define a primary axis, wherein the primary axis and the longitudinal axis define a bias angle therebetween, and wherein the bias angle is in a range of between about 0 degree and about 90 degrees.

12. The display system of claim 10, wherein the plurality of microstructures has a peak to valley height in a range of between about 2.4 microns and about 10 microns.

13. The display system of claim 10, wherein the plurality of microstructures has a pitch in a range of between about 2 microns and about 50 microns.

14. The display system of claim 10, wherein at least one of the first optically clear adhesive layer and the second optically clear adhesive layer has a refractive index of between about 1.47 and about 1.49.

15. The display system of claim 10, wherein a thickness of the first optically clear adhesive layer is greater than a peak to valley height of the plurality of microstructures.

16. A method of manufacturing an article for use with a display device, the method comprising:
providing a diffraction grating film comprising a base layer and a plurality of microstructures projecting from the base layer, wherein the base layer defines a non-structured surface of the diffraction grating film and the plurality of microstructures define a structured surface of the diffraction grating film opposite to the non-structured surface;
providing a first optically clear adhesive layer on the structured surface of the diffraction grating film; and
providing a second optically clear adhesive layer on the non-structured surface of the diffraction grating film.

17. The method of claim 16, further comprising rotating the diffraction grating film to a bias angle.

18. The method of claim 16, further comprising die cutting the diffraction grating film to a bias angle.

19. The method of claim 17, wherein the bias angle is in a range of between about 20 degrees and about 70 degrees.
